(19) United States
(12) Patent Application Publication
(10) Pub. No.: US 2003/0055841 A1
(43) Pub. Date: Mar. 20, 2003

(54) Durability wizard

(76) Inventors: Thomas Stuart Levin, West Chester, OH (US); Michael James Wagner, Loveland, OH (US); Dwight Collins Wilson, Cincinnati, OH (US); Jonathan Martin Wood, Liberty Township, OH (US); Craig Leonard Brocklehurst, Cincinnati, OH (US); John Collier How, Loveland, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/943,785

(22) Filed: Aug. 31, 2001

(51) Int. Cl. G06F 17/00; G06F 7/00

(52) U.S. Cl. 707/104.1; 705/1

(57) ABSTRACT

An internet-based system and method are provided for allowing access to product upgrades, enhancements, developments and service opportunities. A database is configured with dynamically changing product data. A user can provide sufficient information on existing products of the user to access related product information. The related product information provided is up-to-date timely information relating to available service bulletins, upgrades and enhancements, addressing specific customer data.

### BACKGROUND OF THE INVENTION

The present invention relates to a web-based wizard and, more particularly, to the ability to provide updated information, including program offerings, and the ability to assess the quantified benefit of such updated information, to users of the web-based wizard.

Currently, many industries have customers to whom they offer service bulletins, commercial service manuals, and product and data updates. This “value sell” process is a major manual effort. Service bulletins, for example, are offered to customers, and the customer determines whether to implement the service information in the bulletin. The determination is based on a number of factors including cost of incorporating the service information and potential improvement in the product as a result of incorporating the service information.

Traditionally, this labor-intensive effort is done by gathering data from the customer and various organizations. The data is then processed and a “value sell” is physically presented to the customer, based on the collected data. The customer then quantifies the value of the “value sell” using traditional (manual) efforts. Bringing new product enhancements and developments to the attention of the customer is one level in the process, while the determination of value realized by the customer in implementing such enhancements and developments is another level in the process.

It would be desirable to provide a system or method that would provide the “value sell” information to the customer without the manual effort currently required, and assist the customer in assessing the quantified benefit of the information.

### BRIEF DESCRIPTION OF THE INVENTION

A wizard is proposed for providing up-to-date and timely information to customers regarding available service bulletins, product and data offerings, and other upgrade and enhancement possibilities. The wizard can assist customers in gauging the value of implementing the information.

Accordingly, the present invention provides a database for accessing up-to-date and timely information relating to existing products and fleets of a customer. The wizard database is an environment in which knowledge and tools for receiving information and evaluating the value of implementing such information, by reconfiguring and/or replacing products or fleets.

Accordingly, the present invention provides a central database for housing product information. The database further operates as a repository of timely information to help customers become more productive and to increase the awareness of and incorporation rate of service bulletins, product enhancements and new developments.

### BRIEF DESCRIPTION OF THE DRAWINGS

FIG. 1 is a schematic block diagram illustrating a durability wizard system to provide information to users or customers;

FIG. 2 is a schematic block diagram illustrating the flow of information to the customer;

FIG. 3 is an exemplary web page illustrating a user interface for accessing the flow of information; and

FIG. 4 is an exemplary web page illustrating information received by a user when accessing the flow of information.

### DETAILED DESCRIPTION OF THE INVENTION

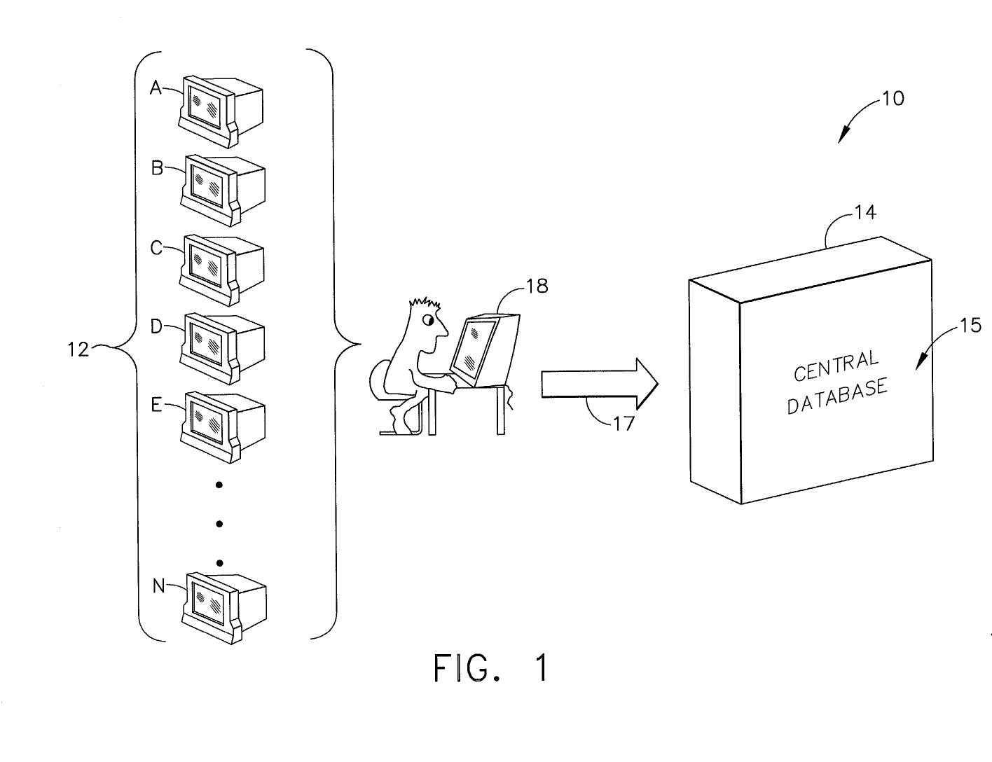

Referring to FIG. 1, system 10 comprises one or more user computers 12A-12N that are representative of separate listings for each customer in the system. Each customer external to the entity or company owning the database will typically have access only to its own listing; while customers internal to the database ownership entity will typically have access to all of the data in the database. The listings can be updated online, as the customer or owner entity provides information relating to purchases and/or development enhancements of the customer.

System 10 is configured to provide an online interface (website) whereby customers can input product information requests, and obtain timely information relevant to the product, including service manuals, service bulletins, new product enhancements and product developments. It will be obvious to those skilled in the art that the information dissemination concept of the present invention can be applied to a multitude of engineering or development type systems, and disseminate a variety of information, without departing from the scope of the invention.

The system 10 comprises a network interconnecting a server 14 and the plurality of users or customers 12A-12N. In one embodiment, the users 12A-12N comprise computers having a web browser. Server 14 is accessible to customers 12A-12N via the Internet or an intranet. The server can be configured to store and download text and digital images. The users are interconnected to the Internet through any suitable interface such as dial-in-connections, cable modems, Internet access, special high-speed ISDN lines and networks such as local area networks (LANs) or wide area networks (WANs). Alternatively, the users can be any client system capable of interconnecting to the Internet including a web-based phone or other web-based connectable equipment.

The listings can be updated online, as the user inputs specific field issues, or product model information. The structure of the system 10 allows for each user 12A-12N to interface with the server 14, conveying information to the central database 15, through an input means 18. The input means can comprise manual or automatic input means, including an input wizard. The interface includes an input portion and an output portion. The input portion of the interface is used to convey information from the user computer to the server 14 and the database 15. Typically, the input information is generated by the user's actuation of an input peripheral, such as a mouse or a keyboard. The output portion conveys information from the server 14 to the user computer and is typically displayed on the monitor of the user computer. However, the output portion is capable of being displayed on other output peripherals, like printers.

The server 14 is configured with the database 15 of product related data, and further configured with a user interface 17 for allowing a user 12A-12N to input information into the database 15 for upload to the server 14. The interface 17 can be provided by any suitable means, such as by web pages that can be transmitted from the database to the user. The input information can include field issues or product and model information from the user. The user can then download information from the database 15, including service bulletins, new product enhancements, product development information, and remediation programs for specific field issues. The input means 18 filters information between the user 12A-12N and the server 14. The connection means or user interface 17 connects the computer of each user 12A-12N to the server 14.

In a preferred embodiment, server 14 is configured to host a plurality of web pages that allow users and customers to enter specific field issues and product information for upload to the server 14 via the input wizard 18. The input wizard 18 ensures consistent and relevant data is input to the server 14 and the database 15 from each user location. This is accomplished through use of a series of data fields requiring input information on existing products of the user. The separate users each benefit from the expanded sources for data, such as related field issues, and timely availability of information.

The server 14 can provide real time information on field issue remediation programs, technical publications, service bulletins, product enhancements and product developments. Once the data is in the central database, the system 10 can generate reports on the data. These reports can be automatically emailed to or otherwise accessed by interested parties. Customers are thereby provided with up-to-date and sufficient information to determine the cost benefit of implementing any service enhancement or upgrade. The available information can be categorized to relate to specific product models and key operational metrics, to generate development opportunities for an entire global entity.

Continuing with FIG. 1, the system 10 can comprise any kind of digital communication network or combination of digital communication networks. For example, the network can include a web browser, local area network (LAN), wide area network (WAN), World Wide Web, or any combination of these networks. Likewise, the user computers 12A-12N and the server 14 can be of any form so long as the relevant information can be communicated between a user computer and the database 15 of server 14.

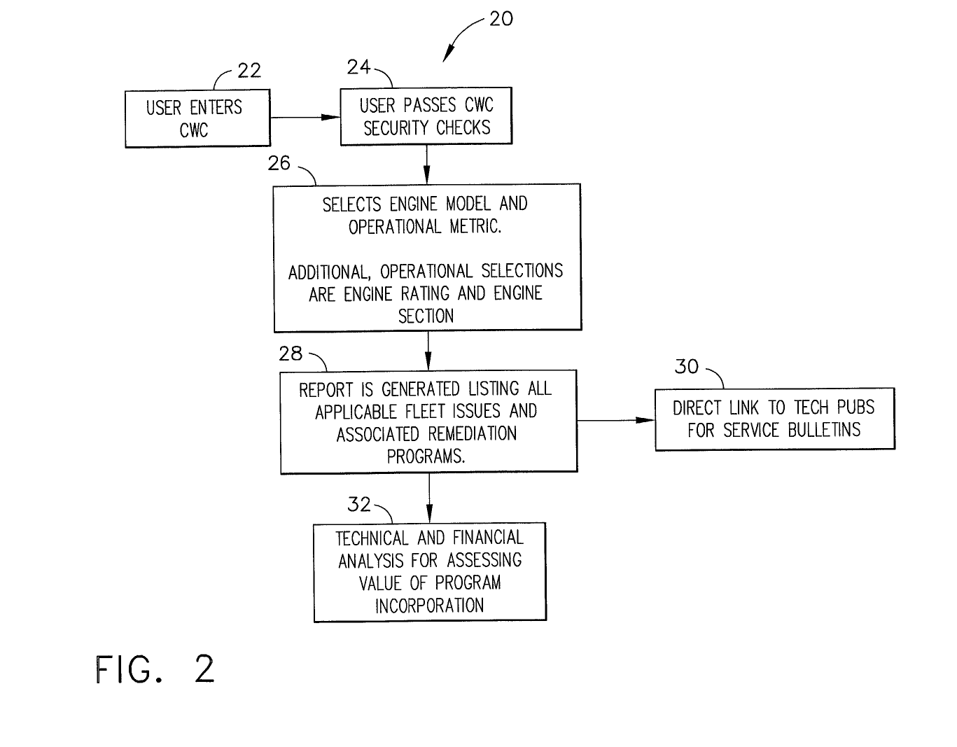

Server 14 is configured with databases and applications that allow users and customers to access and store information regarding available updates. For example, in one embodiment, as illustrated in FIG. 2, a user can directly access a database of field issues after the user inputs some initial parameters regarding product model and key operational metrics. A report can then be generated that will list available programs based on the information provided by the user. The user can further drill down into the report and access technical publications to retrieve detailed information about service bulletins. The server 14 and the users 12A-12N can communicate with each other through the Internet and supply information from their local systems into the centralized database.

A user can access the system 10, typically via an external interface such as the Internet. Once the user is verified as an authorized user, access is granted to the database or application needed by the user. Exemplary schematic block diagram 20 illustrates a sequence of events for accessing information relating to existing products of a customer. Initially, at step 22, a user enters the customer web center. The system 20 comprises at least one user, although multiple users 12A-12N are likely to be accessing the system. At step 24, the user passes customer web center security checks to be able to access relevant information, based on the identity of the user. Typically, each user will have access to only the information relevant to data on that user. For example, at step 26, a user can select relevant product information by selecting model and operational metric numbers for an existing product. Additional operational selections may also be input, for example, for an aircraft engine, an engine rating and engine section may be input. A report can be generated, as indicated at step 28, listing available issues and programs relating to the input information. The report generated at step 28 changes dynamically with the status of the program and the user inputs. The user can further drill down into the report to directly access technical publications and retrieve detailed information such as service bulletins and approved product enhancements, as shown by step 30. Additional analysis and assessment of remediation programs and other information in the report can be provided, as indicated at step 32.

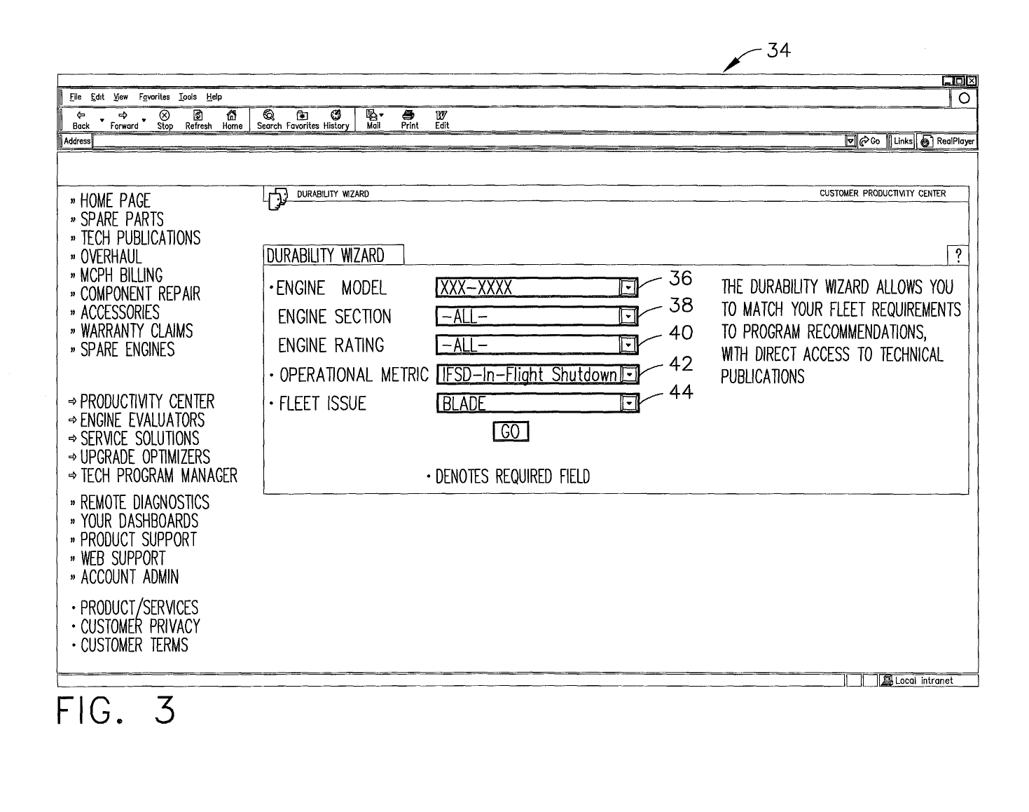

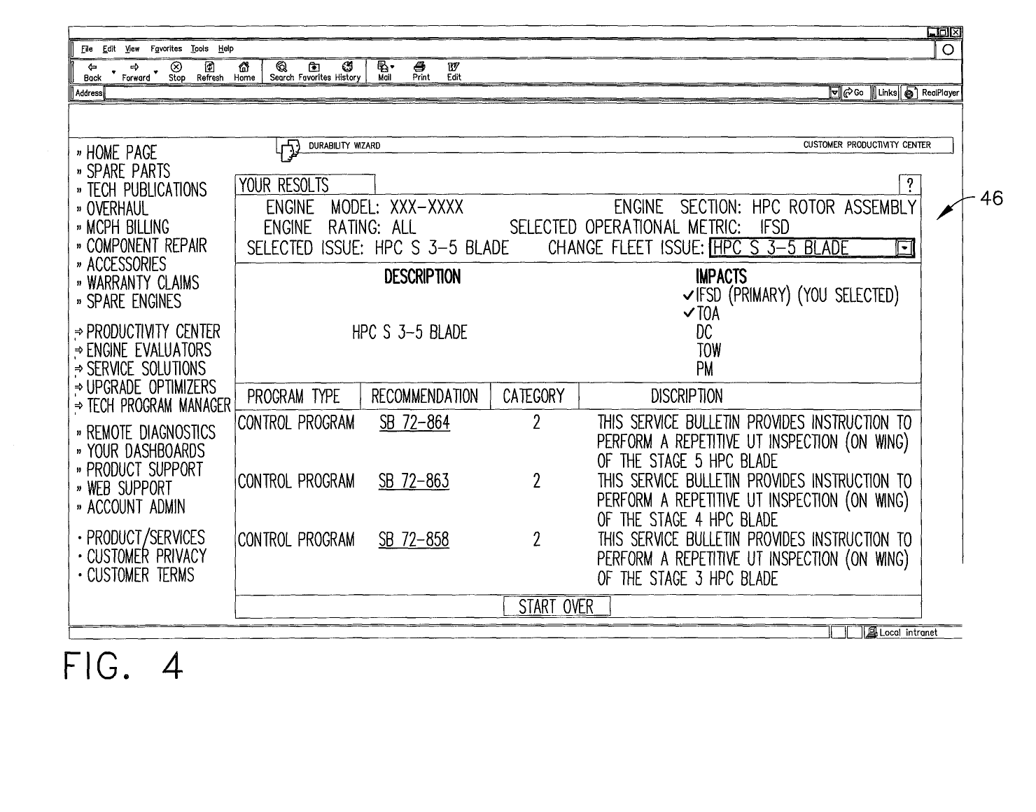

Continuing with FIG. 2 and referring also to FIG. 3, there is illustrated an exemplary screen 34 of the type presented to a user at step 26 in FIG. 2, after the user has passed the security checks at step 24. The exemplary screen 34 allows the user to match fleet requirements to program recommendations. For example, if the customer is requesting information regarding engines, exemplary screen 34 will allow the user to identify an engine model at line 36, an engine section at line 38, an engine rating at line 40, an operational metric at line 42, and a fleet issue at line 44. Based on the information selected and input by the user at exemplary screen 34, a report is generated, such as is illustrated by exemplary screen 46 of FIG. 4. The report offers direct access to program information and corrective actions.

The invention is described herein as a means for bringing to the attention of a customer a new product enhancement, product developments, and product information, in the customer's own environment without the pressure of a salesman. The customer can access relevant information, run iterative scenarios to gage potential improvements in fleet performance, and gage the value of implementation and fleet configuration for optimal performance. It will be obvious to those skilled in the art, however, that the information access concept of the present invention can be applied to a multitude of engineering or development type systems without departing from the scope of the invention.

Although the configuration described herein refers to a server being geographically and physically separated from each user link, this does not preclude integrating the website data and information into each of the user sites to create a stand-alone system. In such a case, it is feasible to use a network to update the information resident in each of the computers. It is also feasible to download website information and data to the user computer each time information is to be input.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system configured for providing access to product development and enhancement information, comprising:
a server configured with a database of product related data, said server capable of allowing a user to input information into the database for upload to said server including product identification information of said user and allowing a user to download information from the database including service enhancement and upgrade opportunities;
at least one computer;
an input means for filtering information between the user and the server; and
an interface between the at least one computer and the server.

2. A system as claimed in claim 1 wherein the product information from the user is reviewed for potential service opportunities.

3. A system as claimed in claim 1 wherein the input means comprises a wizard.

4. A system as claimed in claim 1 wherein access to said server is configured to be secured by user password.

5. A system as claimed in claim 1 wherein said user comprises multiple users.

6. A system as claimed in claim 5 wherein the database is owned by an owner entity.

7. A system as claimed in claim 6 wherein the multiple users comprise users internal to the owner entity and users external to the owner entity.

8. A system as claimed in claim 1 wherein the interface is provided by web pages that can be transmitted from the database to the user.

9. A system as claimed in claim 1 wherein the service enhancement and upgrade opportunities comprise service bulletins.

10. A system as claimed in claim 1 wherein said server is configured to store and download text and digital images.

11. A method for providing access to product development and enhancement information for internal users and external users using a system which includes a server and at least one user computer, the method comprising the steps of:
uploading product information of a user to the server;
downloading from the server, web pages configured to direct internal and external users to a database of related product information within the server, the database configured with remediation programs, and product enhancement and product development data;
uploading user selections input into the web pages to the server;
downloading from the server product and development opportunities responsive to the user supplied data; and
using an input means to filter information between the user and the server.

12. A method as claimed in claim 11 further comprising the step of configuring the server to be secured by user password.

13. A method as claimed in claim 11 wherein the product information from the user is reviewed for potential service opportunities.

14. A method as claimed in claim 11 further comprising the step of configuring the server to store and download text and digital images.

15. A method as claimed in claim 11 wherein the step of downloading from the server, web pages configured to direct internal and external users to a database and related applications within the server, further comprises the step of downloading from the server, web pages configured with related product information including service bulletins and technical publications.

16. A method as claimed in claim 11 further comprising the step of configuring the server to allow for a customized output feature.

17. A method as claimed in claim 11 further comprising the step of configuring the server to have a search capability for finding product data meeting a specified set of criteria.
